(19) United States
(12) Patent Application Publication
(10) Pub. No.: US 2010/0161972 A1
(43) Pub. Date: Jun. 24, 2010

(54) DEVICE AND METHOD FOR KEY BLOCK BASED AUTHENTICATION

(75) Inventors: Antonius Adriaan Maria Staring, Eindhoven (NL); Johan Cornelis Talstra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,262

(22) PCT Filed: Jun. 26, 2006
(86) PCT No.: PCT/IB06/52087

§ 371 Date: Dec. 20, 2007

(30) Foreign Application Priority Data
Jun. 29, 2005 (EP) 05105837.8

(51) Int. Cl. H04L 29/06

(52) U.S. Cl. 713/158

(57) ABSTRACT

The invention relates to a device (250) and a method for key block based authentication. In order to overcome the problems of known devices and method for authentication and to allow for an effective key block and/or application revocation wherein it is ensured that valid and new revocation information reaches said device and is used for authentication, a device (250) for a key block based authentication is proposed comprising authentication means (252) for authenticating between said device (250) having revocation information (254) and an application unit to be authenticated having a key block (AKB) by means of said revocation information (254) and said key block (AKB), and internal trigger means (256) for triggering a process of renewing of said revocation information (254).

The invention relates to a device and a method for key block based authentication.

In recent years, Broadcast Encryption (cf. A. Fiat and M. Naor, Broadcast Encryption, Advances in Cryptology—CRYPTO '93, Lecture Notes in Computer Science 773, Springer, 1994, pp. 480-491, D. M. Wanner, E. J. Harder and R. C. Agee, Key Management for Multicast: Issues and Architectures, Internet RFC 2627, June, 1999 and C. K. Wong, M. Gouda and S. Lam, Secure Group Communications Using Key Graphs, SIGCOMM 1998. Wong, et al) has proven to be a very popular way to solve the key distribution and revocation problems in the field of copy protection. E.g. systems such as Copy Protection for Recordable Media and Copy Protection for Pre-recorded Media (CPRM, CPPM, cf. http://www.4centity.org), Content Protection System for Blu-ray Disc Rewritable (BD-RE CPS, Matsushita/Philips/Sony), and Video Content Protection System (cf. http://www.licensing.philips.com/vcps, HP/Philips) use key blocks to ensure that only compliant playback and recording devices are able to access content.

The general idea behind broadcast encryption is that the total set of all devices is covered by a plethora of cleverly chosen subsets. To every one of those subsets a group-key is assigned. The group-key is embedded in all devices which belong to the corresponding subset. A particular device is a member of multiple subsets and therefore has multiple group-keys on board. This set of group-keys on board of a device is also referred to as its Device Keys. To restrict the access to a piece of content to the set of compliant devices, the content is encrypted with a root key Kᵣₒₒₜ, and Kᵣₒₒₜ in turn is encrypted with several different group-keys. The group-keys are chosen in such a way that the corresponding subsets cover exactly the set of compliant devices, but no more than that. The structure containing Kᵣₒₒₜ encrypted with the group-keys is called the Key Block.

When one or more formerly compliant devices are found to be hacked, new content is encrypted with a new root key K′ᵣₒₒₜ and this key is transferred to the remaining compliant devices using a new key block. The group-keys used for this key block now correspond to a new collection of subsets which covers only the new set of compliant devices. By choosing a new collection of subsets, by creating a new key block, in effect a set of devices may be revoked.

The advantage of broadcast encryption over alternatives is that it combines low transmission requirements (the size of the key block is roughly proportional to the number of non-compliant/revoked devices, usually less than a few thousand) with its low complexity: only symmetric key cryptography is required to decode a key block. Moreover, revocation and key-distribution are conveniently rolled into one.

A relatively new application of broadcast encryption is its use in authentication. As in the example above, devices still have an embedded set of device keys, wherein every device has a different set of device keys, which compliant devices can be used to decode a key block, but non-compliant devices cannot. By using the root key of the key block as a shared secret in a challenge response protocol, one device can verify that another device, e.g. a recorder requesting content from a set top box, is (still) compliant. Examples of this use of broadcast encryption can be found in systems such as xCP (for devices to join a home network, cf. IBM response to DVB-CPT Call for Proposals for Content Protection & Copy Management, DVB-CPT-716, October 2001 http://www.almaden.ibm.com/software/ds/ContentAssurance/papers/xCP_DVB.pdf), and VCPS.

Although the advantages of broadcast encryption in content distribution carry over to authentication, unfortunately there is also a major disadvantage: the key publishing attack. The problem is that this hack allows a single sophisticated hacker to supply many casual hackers with a software tool such that these unauthorized casual hackers can authenticate with a compliant device, in such a way that the keys used in this tool cannot be revoked. The method of this hack is as follows.

Since no implementation of a key block decoding is perfect, there always may be a device in the entire population where the device keys can be retrieved by a relatively sophisticated hacker. In particular software applications are vulnerable in this respect.

The sophisticated hacker uses the device keys to retrieve the root key from any key block on which he can get his/her hands. It has to be noted that key blocks themselves are not confidential and are freely distributed. The root keys retrieved from the key blocks are collected in a database on a server on the internet together with a reference, e.g. a hash, to the key block from which they originated.

A casual hacker wishing to authenticate to a compliant device, e.g. to obtain content, or to join a home network, downloads a tool from the interne which will impersonate a compliant device. When the challenge-response protocol with the compliant device is started, the tool sends a reference, e.g. a hash, of the key block used in the protocol to the server mentioned above; the server returns the corresponding root key which is subsequently used by the tool in the protocol.

Because the device keys used by the sophisticated hacker are never published and only root keys are published, it is very difficult to revoke these device keys in new key blocks.

One way to deal with this attack is to use public key encryption instead of broadcast encryption. In authentication based on public key encryption, every device has its own unique identity fixed in a certificate signed by a certificate authority. Because of the asymmetric nature of public key encryption, there is no need for a shared secret like a root key, and although a sophisticated hacker can still construct a tool for casual hackers, this tool has to be based on the private key of a particular implementation and hence the corresponding public key can be revoked. Unfortunately, public key cryptographic protocols are very expensive in terms of MIPS (for software implementations) and kgates (for hardware implementations), which makes them unpopular for CE products.

Although the key publishing attack suggests that broadcast encryption cannot be used securely for authentication, closer inspection shows that it is still a useful technique as long as the device keys are never present in “weak” implementations. For example, in a situation where hardware is rarely attacked, but software is vulnerable, software should not contain device keys, but hardware could. A system that follows this design criterion is the authentication protocol between a DVD+RW drive and PC host application according to the VCPS, wherein device keys are embedded in all DVD+RW drives and every software application contains it own unique key block and root key, but no device keys.

Software applications can still be hacked but a (sophisticated) hacker will learn at most a root key. Although this root key might still be used in a key publishing attack, this root key is no longer “anonymous”: since every application has its own unique key block and root key, it is, in principle, possible to revoke the corresponding application.

For a successful application revocation hardware devices should have a mechanism to learn which root keys (i.e. which applications) they can no longer accept because the corresponding application has been found to be compromised. In general, there are two ways to establish this: either by black-listing, i.e. revocation lists are distributed regularly which tell hardware devices which applications are no longer compliant (and implicitly, which are still compliant), or by white-listing, i.e. all applications and their key blocks/root keys are revoked regularly and have to prove themselves anew by using new key blocks.

In either case there is an issue how to enforce the “regular”-phrase above: in the black-listing case the hardware device needs timely revocation information, and for white-listing the device needs a trigger to revoke all current key blocks. Known, e.g. from VCPS, are methods where revocation information (not necessarily key block revocation information) or triggers are delivered through third communications partners, e.g. if the hardware device is an optical drive, application revocation information or a trigger might be included on new optical discs; or if the hardware device is a broadcast tuner (e.g. for ATSC), application revocation information or a trigger might be included in the broadcast stream; if the hardware device is nomadic, i.e. it is connected to many other devices, of which a non-zero fraction is likely not to be revoked, it may receive revocation information or a trigger from such other devices.

However, there are also situations where hardware devices are relatively isolated or can only access the outside world through (software) applications which they cannot trust (establishing this trust is exactly the purpose of the (key block based) authentication). The intervening software application may intentionally block revocation information or triggers from reaching the hardware device, or may e.g. replace new revocation information with old revocation information.

It is therefore an object of the present invention to provide a device and a method for a key block based authentication wherein devices are revoked through the key block and application units are revoked through a separate revocation (black/white-)list, which overcome the above mentioned problems and allow for an effective key block and/or application revocation wherein it is ensured that valid and new revocation information reaches said device and is used for authentication.

The object is achieved according to the present invention by a device for a key block based authentication comprising:
authentication means for authenticating between said device having revocation information and an application unit to be authenticated having a key block by means of said revocation information and said key block, and
internal trigger means for triggering a process of renewing of said revocation information.

The object is also achieved by a corresponding method as claimed in claim 12. The present invention is further related to a computer program comprising computer program code means for causing a computer to perform the steps of said method when said computer program is run on a computer.

The invention is based on the insight that a device may by itself enforce a regular update of its revocation information. Instead of waiting for an external event or trigger a device may generate its own trigger in order to obtain new revocation information. In particular, in the absence of reliable delivery channels for revocation information or triggers, the device refuses to engage in the authentication protocol after a “time-out” until the other device (the one wishing to authenticate) supplies “fresh” revocation information or renews its key block.

It has to be noted that the term “device” is not limited to a hardware device. The present invention may also be implemented into a software application, in particular a software application with sufficient hardware support (e.g. a TPM module or running on a special secure chipset like Intel LaGrande or ARM Trustzone) to be securely able to carry device keys as a hardware device. Conversely, the term “application unit” is not limited to a software implementation.

In an embodiment of the present invention said revocation information includes a revocation version number and said internal trigger means is adapted for renewing said revocation information by increasing said revocation version number. Having said revocation version number the device is able to perform an authentication with sufficiently new authentication data. By increasing said revocation version number during said renewing it is ensured that no old authentication data is used for authentication.

In an advantageous embodiment of the present invention the device further comprises communication means for requesting and receiving a black-list of key blocks and/or application units which are revoked and/or a white-list of key blocks and/or application units which are not revoked from said application unit, said black-list and white-list having a version number equal to or exceeding said revocation version number. Further, said authentication means is adapted for using said black-list and/or said white-list for said authentication. Said device requests as new data for authentication a black-list and/or a white-list and is provided with said black-list and/or white-list by said application unit. By checking the entries in said black-list and/or said white-list said device is able to distinguish between application units which are revoked and those which are not revoked. In order to avoid the use of an out-dated black-list or white-list the version number of said list has to be equal to or higher than the revocation version number. Since it is not necessary according to this embodiment to store said black-list or said white-list in said device it is possible to avoid further efforts for securely storing said list(s).

In a further embodiment of the present invention said authentication means is adapted for authenticating only an application unit having a key block with key block version number equal to or exceeding said revocation version number. The revocation version number gives a cut-off between key blocks which are new enough, i.e. which have a sufficiently high version number, and key blocks which are too old, i.e. which have a version number out-dated by said revocation version number.

In yet another embodiment of the present invention said revocation information includes a black-list of key blocks and/or of application units which are revoked and said device comprises communication means for requesting and receiving data for said renewing of said revocation information from said application unit, and replacing means for replacing said black-list by a new black-list received by said communication means. The device stores the black-list on its own and may check upon any occurrence of an authentication event whether the application unit to be authenticated is revoked according to the stored black-list even if said application unit is not able to provide fresh revocation information.

In a further embodiment of the present invention said revocation information includes a white-list of key blocks and/or of application units which are not revoked and said device comprises communication means for requesting and receiving data for said renewing of said revocation information from said application unit, wherein said device further comprises compilation means for deleting said white-list and compiling a new white-list upon provision of authentication certificates for key blocks and/or application units; and/or replacing means for replacing said white-list by a new white-list received by said communication means. By storing the white-list on its own the device is provided with a list of non-revoked application units and/or key blocks. Thus, said device may also authenticate application units which are not in possession of a new white-list.

In an advantageous embodiment of the present invention said revocation information includes further a revocation sequence number in addition to said black-list and/or said white-list, wherein said internal trigger is adapted for increasing said revocation sequence number upon said renewing, and wherein said device is adapted for accepting only data for said renewing having a version number equal to or exceeding said revocation sequence number. In order to ensure that even if the device receives new revocation information (in case of key block black-listing) or is confronted with a new key block (in case of key block white-listing) after a triggering event, it can be certain that this is fresh revocation information or a fresh key block, the device also keeps a revocation sequence number. When the process of renewing is triggered, said revocation sequence number is increased. In the case of a black-list the device will only accept a key block revocation list with an embedded version number equal to or exceeding the revocation sequence number wherein in the case of a white-list the device will only accept a new key block or a new white-list with an embedded version number equal to or exceeding to the revocation sequence number.

In another preferred embodiment said device further comprises an internal timer, wherein said internal trigger means is adapted for triggering said process of renewing of said revocation information after a predetermined or randomly chosen period of time. With the provision of a predetermined, fixed time after which new revocation information is to be requested or the revocation version number is increased, said device forces an application unit to receive and transmit new revocation data in regular intervals. Thus, it is ensured that the longest time which an application unit to be revoked may unrightfully but however successfully authenticated by a device is limited to be shorter than said predetermined period of time. Said period of time may also be randomly chosen after each triggering.

In an advantageous embodiment said device further comprises an internal counter for counting the number of authentications, wherein said internal trigger means is adapted for triggering said process of renewing of said revocation information after a predetermined or randomly chosen number of authentications. In another advantageous embodiment said device further comprises an internal meter for measuring the amount of data, in particular content protected data, handled by said device, wherein said internal trigger means is adapted for triggering said process of renewing of said revocation information after a predetermined or randomly chosen amount of data is handled. By using the number of authentications or the amount of handled data as a trigger event it is possible to limit the utility of an application unit which is newly revoked, e.g. in the newest black-list but not in older versions of the black-list. Similar to the provision of a limited time period between two triggering events the damage possibly caused by a newly revoked application unit, e.g. the unrightfully accessed content, is limited.

In yet another embodiment of the present invention said authentication means is adapted for retrieving an identifier substantially uniquely identifying said application unit and an authentication key associated with said application unit, and said device further comprises a non-volatile memory for storing said authentication key. The authentication key obtained during a first authentication may also be used as a secret shared between said device and said application unit and/or to generate or communicate such a shared secret in further instances of communication without the need of an additional authentication.

In another advantageous embodiment of the method according to the present invention said step of authenticating comprises
a first step of receiving an identifier substantially uniquely identifying said application unit and an authentication key associated with said application unit and storing in a non-volatile memory said authentication key by said device and
a second step of generating a bus key shared between said device and said application unit by means of said authentication key,
   wherein said first step is performed once after said process of renewing and said second step is performed in each authentication step till the next step of triggering.

In case of a black-list, the device may check during the authentication that the used key block (version number) does not appear on the revocation list. To this end the device may check a signature on the key block which ties its version number to the key block or root key.

Then, during an update of the revocation list, the device may check that this list has not been tampered with, i.e. the device may verify a signature on the revocation list (if the revocation list is stored internal to the device, this signature check may be necessary only once).

In the case of a white-list, the device may check that the key block is fresh enough, i.e. that the version number of the key block is higher than an internally stored version number. This step also requires that a signature is checked, viz. a signature on the key block which ties its version number to the key block or root key.

Checking signatures is approximately one order-of-magnitude more expensive than symmetric key decryption/encryption and according to the present embodiment of a method for authentication these expensive signature-checking operations may be minimized

The protocols for black-listing white-listing are cut in two parts:
a key block enrollment phase (first step), when a new key block is being introduced to the hardware device. This new key block may correspond to a new application or to an old application with a new key block (after white-list revocation). During this phase the hardware device checks signatures and decodes the key block to obtain the root key. The root key or authentication key is subsequently stored in preferably secure and non-volatile storage on board of the device.
an authentication phase (second step) based on the root key (which the device has preferably stored in NVRAM) when the challenge-response part of the authentication protocol is executed. This phase is much more frequent, and takes place every time content is consumed, but this phase does not require signature checking.

It has to be noted that the price to be paid for the cheaper authentication phase is that the hardware device may need to store a root key per application in (secure) NVRAM.

In general this should not be a problem because the device may need (secure) NVRAM anyway to store the revocation sequence number and or revocation version number. Although this requires roughly 16(root key)+4(appl. ID)=20 bytes per application, should NVRAM come at a premium, the hardware device could overwrite less used root keys by root keys which are required more regularly; the consequence is that the less used application has to undergo a signature check of its key block every time it is used.

Typically the enrollment phase is executed when an application wants to authenticate with the hardware device for the first time. A convenient implementation of key block revocation via black-listing is to strike the root key of an application from NVRAM, when this application or its key block has appeared on a key block revocation list. A convenient implementation of key block revocation via white-listing is to strike all the root keys from NVRAM, when a trigger or time-out signal is received.

In the following the present invention will be described further with respect to the accompanying figures, in which:

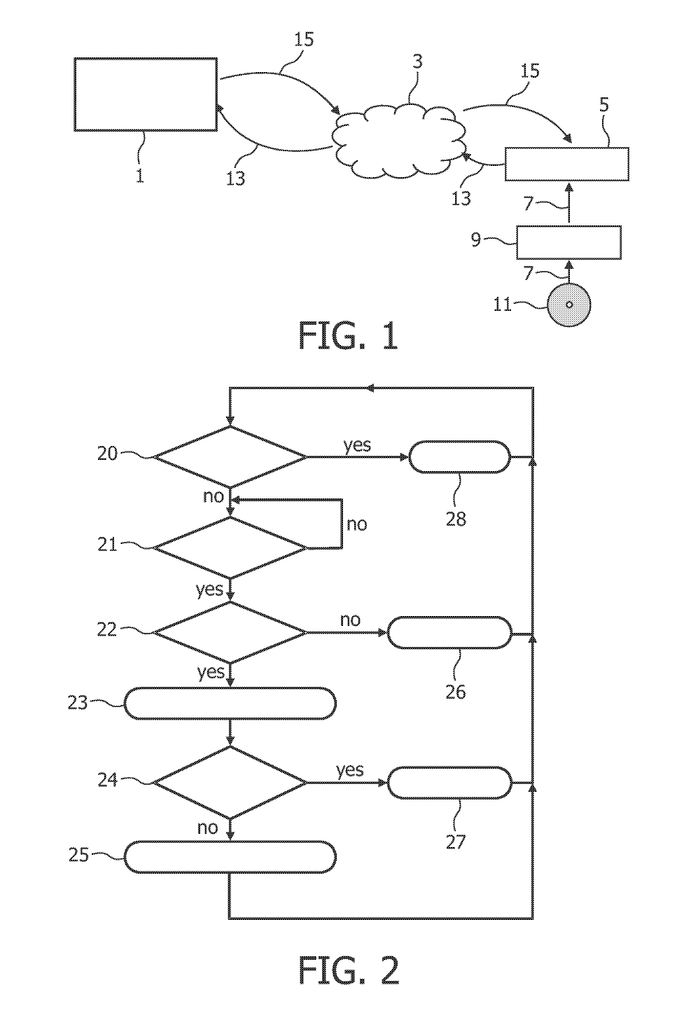

FIG. 1 is a block diagram illustrating a key publishing attack,

FIG. 2 is a flowchart of the authentication protocol for the case of a black-list according to an embodiment of the present invention,

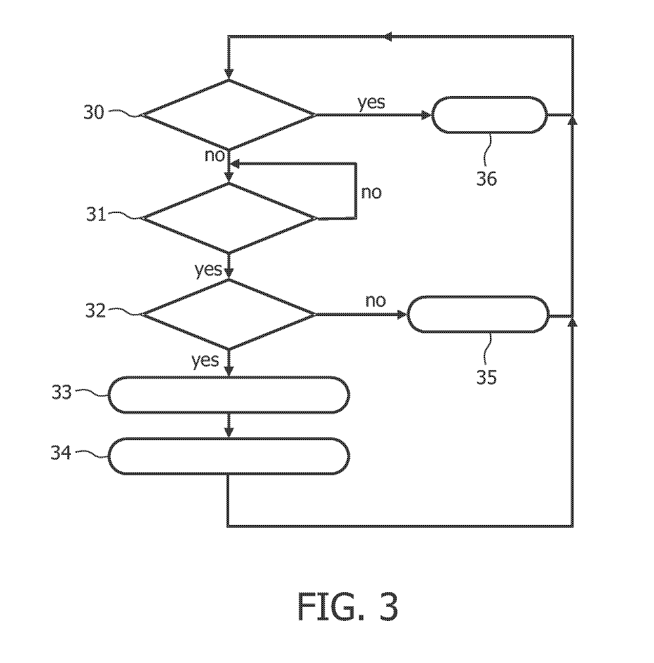

FIG. 3 is a flowchart similar to that of FIG. 2 for the case of a white-list,

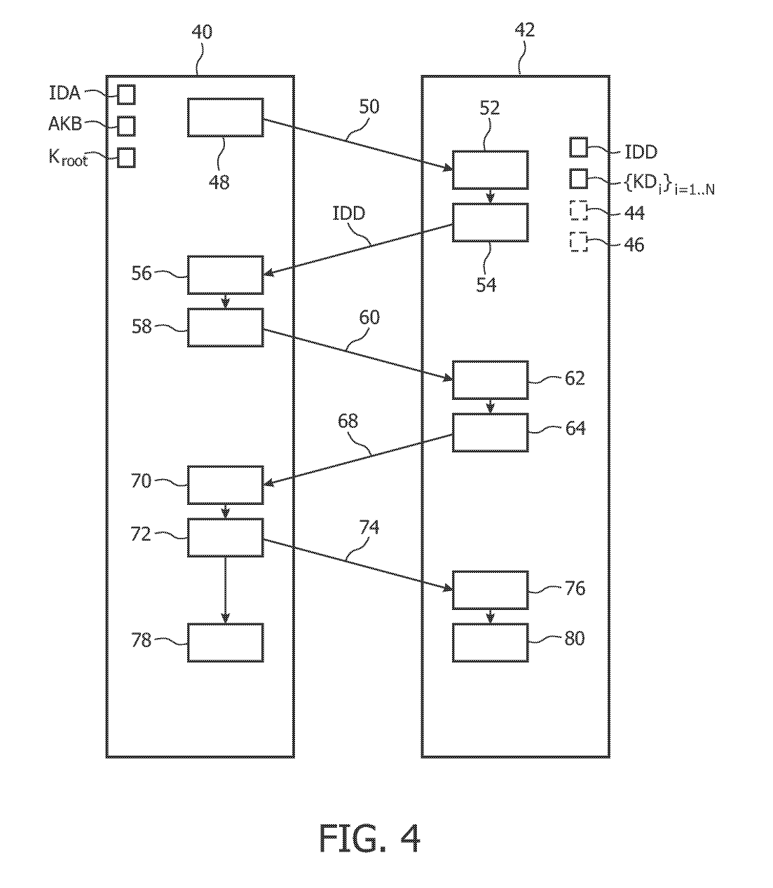

FIG. 4 is a block diagram of an authentication protocol known from VCPS,

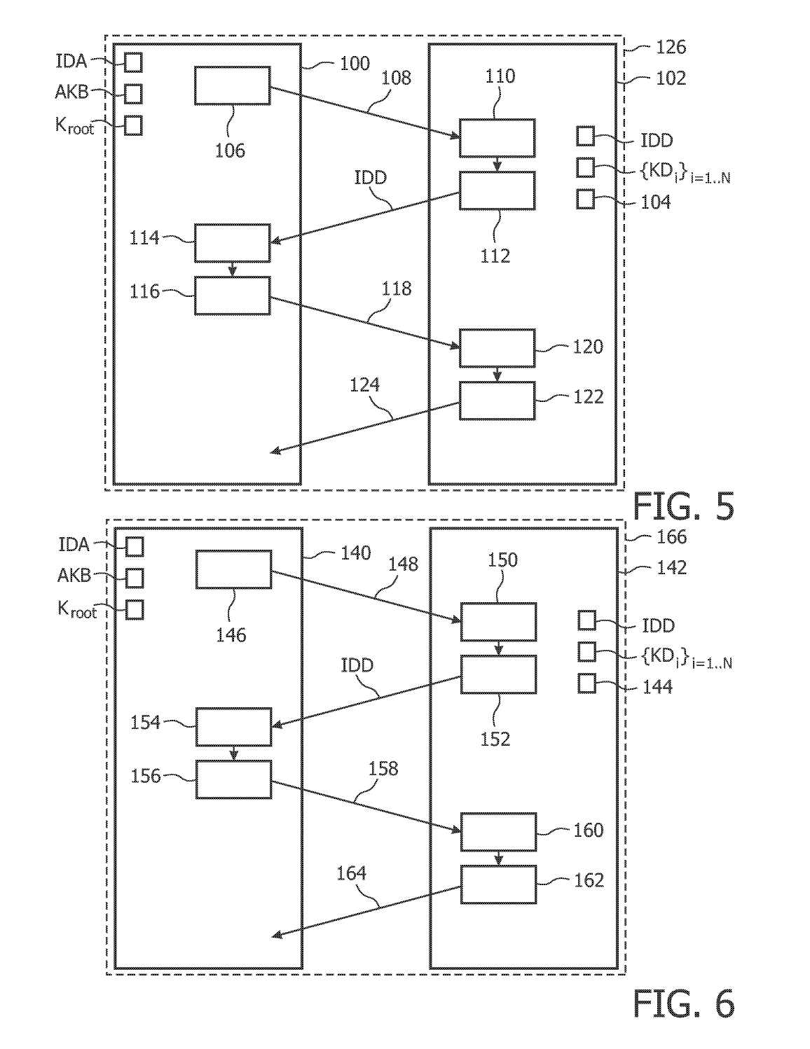

FIG. 5 is a block diagram showing a first part of the step of authenticating according to the present invention for the case of a black-list,

FIG. 6 is a block diagram showing a first part of the step of authenticating according to the present invention for the case of a white-list,

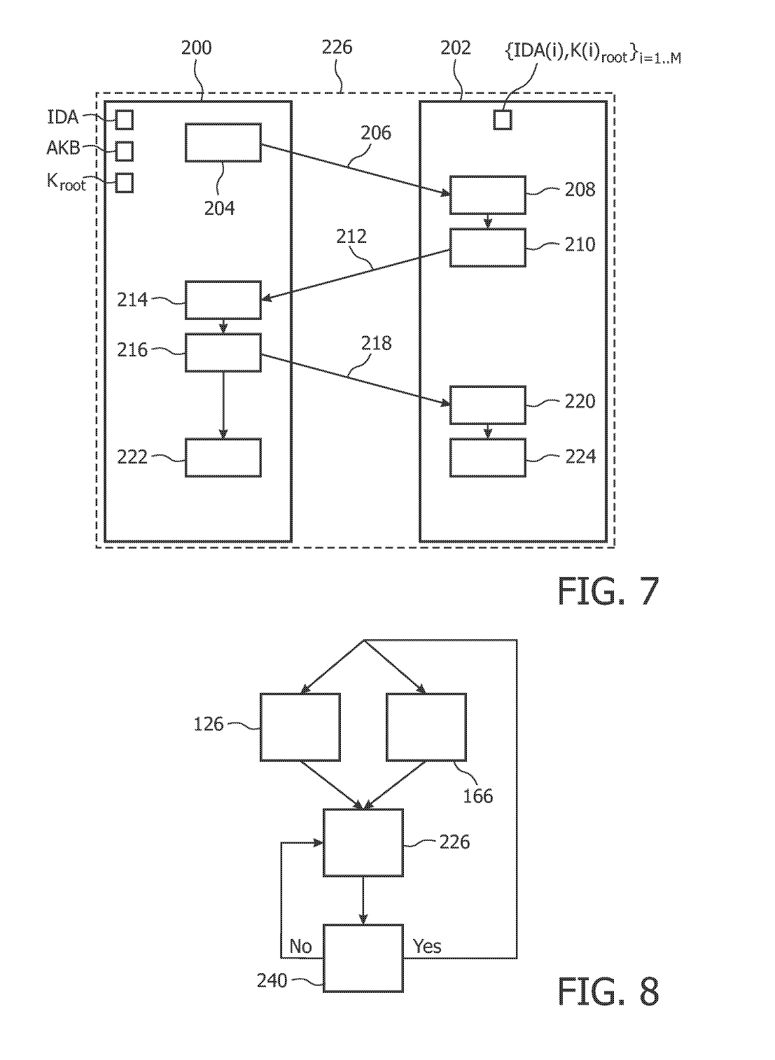

FIG. 7 is a block diagram showing a second part of the step of authenticating according to the present invention,

FIG. 8 is a flowchart illustrating the method of authenticating according to the present invention, and

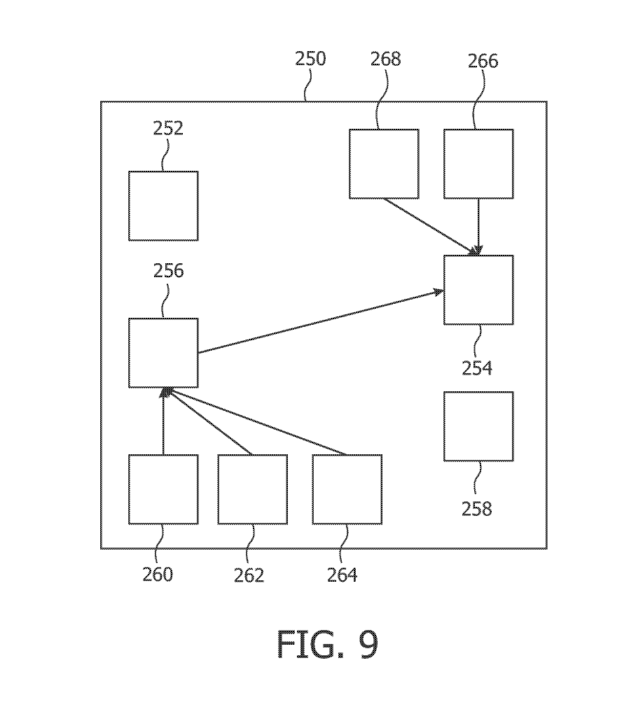

FIG. 9 is a block diagram showing a device for authentication according to the present invention.

FIG. 1 is a block diagram illustrating a key publishing attack. A (sophisticated) hacker obtains a set of device keys by hacking, e.g., a software application, and decodes the root keys from any available key block. These root keys are stored in a database 1 which may be accessed trough a communication system 3, e.g. the internet. A special player software application 5 emulates a compliant graphics card and obtains content encrypted by means of a root key and a key block having said root key from a (non-revoked) playback software application 9, e.g. for a Blu-ray disc 11. An indicator 13, e.g. a hash-value, of said key block is used to access said database 1 via the internet 3 and to obtain said root key 15 in return. This root key 15 or media key may be used by said special player software application 5 to decode the encrypted content 7 and thus to access said content.

FIG. 2 is a flowchart of the authentication protocol for the case of a black-list according to an embodiment of the present invention. In step 20 it is checked by the device whether a time-out event has occurred, i.e. whether there is a triggering for a process of renewing revocation information. If there is no such time-out event it is checked in step 21 whether there is a present authentication request. This check is repeated until an authentication is requested and the device is provided with a black-list and a key block. If the version number of said revocation list is equal to or exceeds (step 22) the revocation version number stored in said device the authentication protocol is continued with step 23, wherein the revocation version number is given the value of the version number of the key block. In step 24 it is checked whether the used key block is in said revocation list. If said key block is proven to be valid, i.e. not mentioned in said revocation list or black-list, the further steps for an authentication are performed (25).

If in step 22 it is found that the version number of the black-list is lower than the revocation version number, or if in step 24 it is found that the present key block is revoked according to the black-list, the authentication is aborted in step 26 or 27, respectively, and the protocol continues with step 20. If in step 20 it is found that there is a time-out event, i.e. the internal trigger means of said device triggered a process of renewing, the revocation version number is increased in step 28 and the process is again continued with step 20.

FIG. 3 is a flowchart similar to that of FIG. 2 for the case of a white-list. In step 30 a check for a time-out event or a triggering is performed. If there is no such triggering a check for an authentication request follows in step 31 which is repeated until an authentication is requested and a key block is provided. If according to step 32 the version number of said key block is lower than the revocation version number of said device for authentication the authentication is aborted in step 35 and the process starts again with step 30. If the version number of said key block is found to be equal to or exceeding said revocation version number, said revocation version number is updated to have the value of said version number of said key block (step 33) and the further steps for authentication are performed (step 34). After completion of said authentication the process starts again with step 30.

FIG. 4 is a block diagram of an authentication protocol based on VCPS. An application unit 40 is provided with an application identifier IDA, an application key block AKB and the root key or authentication key Kᵣₒₒₜ of said key block AKB. The device 42 is provided with a device identifier IDD and a set of device keys {KDᵢ}_{i=1 . . . N}. In case of black-listing the device 42 is further provided with an AKB revocation list 44 and in case of white-listing the device 42 is further provided with a revocation version number 46. The application unit 40 initiates the authentication protocol (step 48) and sends a request 50 to said device 42. Said request 50 is received 52 and in response 54 said device identifier IDD is sent to said application unit 40. Said application unit 40 searches 56 said application key block AKB for the node which is relevant for said device 42 and obtains an authorization key from said key block AKB. Said authorization key contains said Kᵣₒₒₜ in encrypted form.

Further, an application random number RA is generated 58 and a message 60 is transmitted to said device 42. Said message 60 contains an indicator for the relevant node of said application key block AKB, said authorization key, said random number RA and a certificate or signature of said key block AKB. In step 62 said authentication key Kᵣₒₒₜ is decrypted by means of the appropriate device key KDⱼ. Further, the signature on the header of said application key block AKB in said certificate or signature is checked. Additionally, there is a check whether the obtained root key Kᵣₒₒₜ complies with its shadow in said header.

In case of black-listing the signature on the revocation list is checked. If said device 42 stores its own revocation list this check has to be done only once after storing but if said device 42 is provided with a (new) revocation list upon each instance of an authentication, e.g. by said application unit 40, said check has to be repeated during each authentication. Further, it is checked whether said key block identifier or application identifier IDA is in said revocation list 44.

It is to be noted that in the VCPS authentication protocol the application key block is not revoked directly as described in the previous three paragraphs. Therefore the VCPS authentication protocol lacks the exchanging and checking of a certificate/signature, as well as the interpretation of key block black/white-lists.

In case of white-listing the version number in the header of said application key block is compared to said revocation version number, i.e. it is checked whether the version number of the key block is equal to or exceeds said revocation version number which is preferably stored in a NVRAM.

In step 64 a device random number RD is generated by said device 42 and transmitted 68 together with said application random number RA and a device key contribution KD_{bus} and encrypted by means of said root key Kᵣₒₒₜ to said application unit 40. By means of said root key Kᵣₒₒₜ embedded in said application unit 40 the message 68 is decrypted and its validity is checked by checking for the presence of the correct application random number RA (step 70). In step 72 an application key contribution KA_{bus} is generated which is transmitted 74 to said device 42 together with said application random number RA, said device random number RD and said application key contribution KA_{bus} being encrypted by means of said root key Kᵣₒₒₜ. The validity of this response 74 is checked by checking for the presence of said device random number RD. In steps 78 and 80 a bus key is generated as a one-time shared secret by said application unit 40 and said device 42, e.g. by application a hash-function to the combination of said application key contribution KA_{bus} and said device key contribution KD_{bus}. Thus, the authentication is completed.

It has to be noted that the authentication is aborted by said application unit 40 or said device 42 if any check implies that some part of this authentication is not valid. The certificate checkings in step 62 are expensive and it would be advantageous to avoid or reduce repetitions of this step in order to accelerate the authentication protocol.

FIG. 5 is a block diagram showing a first part of the step of authenticating according to the present invention for the case of black-listing. An application unit 100 is provided with an application identifier IDA, an application key block AKB and the root key or authentication key Kᵣₒₒₜ of said key block AKB. The device 102 is provided with a device identifier IDD, a set of device keys {KDᵢ}_{i=1 . . . N}, and an AKB revocation list 104. Said device 102 may store this revocation list 104 from prior authentication processes or may be provided by other means with said revocation list 104. It is also possible that said device 102 is provided with said revocation list 104 by said application unit 100 as a part of said authentication. Steps 106 to 120 correspond to the steps 48 to 62 described above with respect to an authentication protocol in case of a black-listing. However, there is no generation of an application random number RA in step 116, and thus there is no application random number RA in message 118. If all checks indicate that the authentication is valid and that the application unit 100 is not revoked said application identifier IDA and said root key Kᵣₒₒₜ are stored together (step 122), preferably in a secure non-volatile memory (NVRAM, not shown). Further, an acknowledgement 124 is sent to said application unit 100. Thus, an enrollment phase 126 for a black-listing is completed according to the present invention.

FIG. 6 is a block diagram showing a first part of the step of authenticating according to the present invention for the case of white-listing. An application unit 140 is provided with an application identifier IDA, an application key block AKB and the root key or authentication key Kᵣₒₒₜ of said key block AKB. The device 142 is provided with a device identifier IDD, a set of device keys {KDᵢ}_{i=1 . . . N}, and revocation version number 144. Steps 146 to 160 correspond to the steps 48 to 62 described above with respect to an authentication protocol in case of white-listing. However, there is no generation of an application random number RA in step 156, and thus there is no application random number RA in message 158. If all checks indicate that the authentication is valid and that the application unit 140 is not revoked said application identifier IDA and said root key Kᵣₒₒₜ are stored together (step 162), preferably in a secure non-volatile memory (NVRAM, not shown). Further, an acknowledgement 164 is sent to said application unit 140 similar to the above described authentication according to the present invention for the case of black-listing. Thus, an enrollment phase 166 for a white-listing is completed according to the present invention.

FIG. 7 is a block diagram showing a second part of the step of authenticating according to the present invention. This second part is the same for an authenticating using a black-list and an authentication using a white-list. An application unit 200 is provided with an application identifier IDA, an application key block AKB and the root key or authentication key Kᵣₒₒₜ of said key block AKB. The device 202 is provided with a list of associated application identifiers and root keys {IDA(i), K(i)ᵣₒₒₜ}_{i=1 . . . m}. This list of application identifiers IDA(i) and root key K(i)ᵣₒₒₜ may be obtained by a number of previous enrollment-phases 126, 166 for black- and/or white-listing as described above. Said second part is initiated (step 204) by said application unit 200 by generating an application random number RA and sending a message 206 including said application random number RA and said application identifier IDA to said device 202. Said device 202 looks up the root key Kᵣₒₒₜ of said application key block AKB using said application identifier IDA in said list of application identifiers and root keys (step 208). A device random number RD and a device key contribution KD_{bus} is generated by said device 202 (step 210) and sent to said application unit 200 as a transmission 212. Said transmission 212 contains in encrypted form said application random number RA, said device random number RD and an device key contribution KD_{bus}. Said transmission is encrypted using said root key Kᵣₒₒₜ corresponding to said application unit 200 and said application key block AKB. Said transmission 212 is verified by checking for the correct application random number RA, wherein said transmission 212 is decrypted by means of said root key Kᵣₒₒₜ of said application unit 200 (step 214). In step 216 an application key contribution KA_{bus} is generated and a message 218 is transmitted to said device 202. Said message contains said application key contribution KA_{bus}, said application random number RA and said device random number RD encrypted using Kᵣₒₒₜ. The validity of said message 218 is checked by decrypting it using Kᵣₒₒₜ and checking for the presence of the correct device random number RD. In steps 220 and 222 a bus key is generated as a one-time shared secret by said application unit 200 and said device 202, e.g. by applying a hash-function to the combination of said application key contribution KA_{bus} and said device key contribution KD_{bus}. Thus, the second part 226 of an authentication protocol according to the present invention is completed.

FIG. 8 is a flowchart illustrating the method of authenticating between a device and an application unit according to the present invention. A first part of said method of authenticating is formed by an enrollment phase 126, 166 for providing said device with an application identifier IDA and the corresponding root key Kᵣₒₒₜ as described above. Said enrollment phase 126, 166 is followed by a second part 226 of said authenticating providing said application unit and said device with a (one-time) shared secret K_{bus}. After completion of said second part it is checked whether the internal trigger means has triggered a process of renewing (step 240). If there is no such triggering event a repetition of said second part 226 may follow. If there is such a triggering event, the revocation information of said device is renewed and accordingly new enrollment phases 126, 166 will follow.

FIG. 9 is a block diagram showing a device 250 for authentication according to the present invention. Said device 250 comprises authentication means 252 for an authentication between said device 250 and an application unit (not shown). Said device 250 further has revocation information 254 and internal trigger means 256 for triggering a process of renewing said revocation information. Said device 250 is provided with a communication means 258 for communicating with said application unit, in particular for requesting and receiving data for said renewing and/or for requesting and receiving (new) revocation information. Connected to said internal trigger means 256 are an internal timer 260, an internal counter 262 and an internal meter 264 for causing said internal trigger means 256 to trigger said process of renewing. Said device 250 further comprises replacing means for replacing said revocation information by new revocation information received during said process of renewing and compilation means for deleting outdated revocation information and for compiling new revocation information during and after said process of renewing.

Because of the Key Publishing Attack, key block-based broadcast encryption is commonly considered to be not suitable for authentication. However, the Video Content

Protection System VCPS by Philips and HP (cf. http://www.licensing.philips.com/vcps) introduced a way to use broadcast encryption avoiding this attack by restricting the use of device keys to hardware devices, and giving every (vulnerable) software application its own key block and root key. In this system there is two-way authentication but not two-way revocation, i.e. the software application may revoke the hardware device but the hardware device cannot revoke the software application. According to the present invention this system may be extended to the case of true two-way revocation by introducing key block black-listing (the hardware device regularly obtains a list of key blocks/applications which can no longer be used) or key block white-listing (the hardware device regularly revokes all existing key blocks/applications, and demands new key blocks to continue authentication). A number of solutions for hardware devices to obtain fresh revocation information/full revocation triggers is provided. The present invention is in particular suitable to provide an authentication protocol between a software application and a graphics card or tuner-card in the PC back-end.

After a self-generated time-out, the hardware device may refuse any authentications until a new key block revocation list is delivered (black-list) and/or the hardware device may refuse all authentication with existing key blocks, and will only authenticate with new key blocks until the next time-out (white-list). It is proposed that the hardware device has an internal notion of time, performed authentications and/or handled content. Some other (similar) value may also be used as a “count-down” to a triggering event. This “time” keeping function regularly releases a trigger which signals to the device to refuse any further authentication until new revocation information has been delivered or new key blocks are installed.

Examples of conditions setting off this trigger are:
a) the hardware device has an internal (secure) clock, and after a fixed amount of time, say every 6 months, this clock generates a time-out;
b) the hardware device has an internal counter which increments every time the authentication protocol is run. When it reaches a fixed number, say 512, the trigger is released;
c) the hardware device has an internal counter which keeps track of the amount of content that has been handled. When it reaches a fixed number, say 1000 Gbytes, it triggers.

It has to be noted that suitable measurements should preferably be taken to prevent a tampering with the processing authentication data. For example, in order to prevent an attacker from passing an old revocation list or key block off as a new one, the version number in either the revocation list or the key block is tied to the revocation list or key block in a cryptographically secure manner, e.g. the version number and revocation list/key block are signed together by a licensing or certificate authority. Further, the storage or memory means should preferably be secure and non-volatile.

The present invention may be combined with a grace-period mechanism, e.g. those described in “Grace period for unauthorized device-host interactions” (international patent application PCT/IB2005/051758, attorney docket PHNL040647) which attempts to solve the problem of a system stuck in a dead-lock when one component of this system demands fresh revocation information but the system has no means to access a network to retrieve such information.

1. Device (250) for a key block based authentication comprising:
authentication means (252) for authenticating between said device (250) having revocation information (254) and an application unit to be authenticated having a key block (AKB) by means of said revocation information (254) and said key block (AKB), and
internal trigger means (256) for triggering a process of renewing of said revocation information (254).

2. Device (250) for authentication as claimed in claim 1, wherein said revocation information (254) includes a revocation version number and wherein said internal trigger means (256) is adapted for renewing said revocation information (254) by increasing said revocation version number.

3. Device (250) for authentication as claimed in claim 2,
further comprising communication means (258) for requesting and receiving a black-list of key blocks and/or application units which are revoked and/or a white-list of key blocks and/or application units which are not revoked from said application unit, said black-list and white-list having a version number equal to or exceeding said revocation version number;
wherein said authentication means (252) is adapted for using said black-list and/or said white-list for said authentication.

4. Device (250) for authentication as claimed in claim 2, wherein said authentication means (252) is adapted for authenticating only an application unit having a key block (AKB) with key block version number equal to or exceeding said revocation version number.

5. Device (250) for authentication as claimed in claim 1,
wherein said revocation information (254) includes a black-list of key blocks and/or of application units which are revoked and
wherein said device (250) comprises
communication means (258) for requesting and receiving data for said renewing of said revocation information from said application unit, and
replacing means (266) for replacing said black-list by a new black-list received by said communication means (258).

6. Device (250) for authentication as claimed in claim 1,
wherein said revocation information (254) includes a white-list of key blocks and/or of application units which are not revoked and
wherein said device (250) comprises
communication means (258) for requesting and receiving data for said renewing of said revocation information (254) from said application unit, and
wherein said device (250) further comprises
compilation means (268) for deleting said white-list and compiling a new white-list upon provision of authentication certificates for key blocks and/or application units; and/or
replacing means (266) for replacing said white-list by a new white-list received by said communication means.

7. Device (250) for authentication as claimed in claim 5,
wherein said revocation information (254) further includes a revocation sequence number,
wherein said internal trigger means (256) is adapted for increasing said revocation sequence number upon said renewing, and
wherein said device (250) is adapted for accepting only data for said renewing having a version number equal to or exceeding said revocation sequence number.

8. Device (250) for authentication as claimed in claim 1,
further comprising an internal timer (260), wherein said internal trigger means (256) is adapted for triggering said process of renewing of said revocation information (254) after a predetermined or randomly chosen period of time.

9. Device (250) for authentication as claimed in claim 1,
further comprising an internal counter (262) for counting the number of authentications, wherein said internal trigger means (256) is adapted for triggering said process of renewing of said revocation information (254) after a predetermined or randomly chosen number of authentications.

10. Device (250) for authentication as claimed in claim 1,
further comprising an internal meter (264) for measuring the amount of data, in particular content protected data, handled by said device (250), wherein said internal trigger means (256) is adapted for triggering said process of renewing of said revocation information (254) after a predetermined or randomly chosen amount of data is handled.

11. Device (250) for authentication as claimed in claim 1,
wherein said authentication means (252) is adapted for retrieving an identifier (IDA) substantially uniquely identifying said application unit and an authentication key (Kᵣₒₒₜ) associated with said application unit, and
further comprising a non-volatile memory for storing said authentication key (Kᵣₒₒₜ).

12. Method for a key block based authentication comprising the steps of:
authenticating between a device having revocation information and an application unit to be authenticated having a key block by means of said revocation information and said key block,
internally triggering a process of renewing of said revocation information by said device.

13. Method for authentication as claimed in claim 12,
wherein said step of authenticating comprises
a first step (126, 166) of receiving an identifier substantially uniquely identifying said application unit and an authentication key associated with said application unit and storing in a non-volatile memory said authentication key by said device and
a second step (226) of generating a bus key shared between said device and said application unit by means of said authentication key,
wherein said first step (126, 166) is performed once after said process of renewing and said second step (226) is performed in each authentication step until the next step of triggering.

14. A computer program comprising computer program code means for causing a computer to perform the steps of the methods as claimed in claim 12 when said computer program is run on a computer.
